(19) United States
(12) Patent Application Publication
(10) Pub. No.: US 2018/0136820 A1
(43) Pub. Date: May 17, 2018

(54) COMPUTER READABLE NON-TRANSITORY RECORDING MEDIUM, INFORMATION PROCESSING METHOD AND INFORMATION PROCESSING APPARATUS

(71) Applicant: FUJITSU LIMITED, Kawasaki-shi (JP)

(72) Inventor: Yuuki NAGAO, Kawasaki (JP)

(73) Assignee: FUJITSU LIMITED, Kawasaki-shi (JP)

(21) Appl. No.: 15/804,826

(22) Filed: Nov. 6, 2017

(30) Foreign Application Priority Data
Nov. 14, 2016 (JP) 2016-221953

(51) Int. Cl. G06F 3/0484; G06F 3/0488

(52) U.S. Cl. CPC G06F 3/04842; G06F 17/2247; G06F 3/04883

(57) ABSTRACT

operation performed by user about a displayed Web content. And the program causes the computer to perform presenting selection information associated with the operation, the selection information corresponding to a position change of any of elements of the displayed Web content of the displayed Web content, the selection information being related to timing of the operation. The selection information is configured to specify any of the elements related to a position at which the operation is accepted in the Web content.

### CROSS-REFERENCE TO RELATED APPLICATIONS

This application is based upon and claims the benefit of priority of the prior Japanese Patent Application No. JP2016-221953, filed on Nov. 14, 2016, the entire contents of which are incorporated herein by reference.

### FIELD

The present invention pertains to a computer readable non-transitory recording medium storing a program, an information processing method and an information processing apparatus.

### BACKGROUND

Owing to improvements of performance related to visual recognizability as instanced by improvements of resolutions of displays of smartphones, Web pages of Personal Computer (PC) Web sites can be browsed directly by the smartphones. Additionally, higher performance of the smartphones enables technologies instanced by HyperText Markup Language 5 (HTML5) and Asynchronous JAvascript+ExtensibleMarkupLanguage(Xml) (AJAX) to be utilized on browsers. Each of HTML5, AJAX, Cascading Style Sheets (CSS) and other equivalent languages contains a function of dynamically rewriting a Web page. This function causes a change of an external configuration of the Web page, with the result that a component, intended to be operated by a user, of a Web content moves as the case may be. The Web content herein connotes, like the Web page, information written based on syntaxes of HTML, XML and other equivalent languages, and provided from information provider apparatus such as a Web server to an information display target equipment as in the case of the Web page. A browser displays the Web content on the display target equipment, e.g., the smartphone.

FIG. 1 illustrates a display example of how the external configuration of the Web page changes. In FIG. 1, options for indicating articles 1-5 are displayed on a screen of the smartphone. It is now assumed that a user tries to select the article 1. In this status, a configuration of the screen changes asynchronously with and regardless of a user's operation as the case may be. For example, it might happen that a link to an advertisement is displayed in place of the option of the article 1 immediately before the user touches the option of the article 1. Then, it follows that the user mistakenly selects the advertisement even by operating with an intention of selecting the article 1.

### DOCUMENTS OF PRIOR ARTS

### Patent Documents

[Patent Document 1] Japanese Patent Application Laid-Open Publication No. H11-331464

[Patent Document 2] Japanese Patent Application Laid-Open Publication No. 2006-59238

### SUMMARY

An aspect of an embodiment is illustrated by a computer readable non-transitory recording medium storing a program. The program causes a computer to perform accepting a operation performed by user about a displayed Web content. And the program causes the computer to perform presenting selection information associated with the operation, the selection information corresponding to a position change of any of elements of the displayed Web content, the selection information being related to timing of the operation. The selection information is configured to specify any of the elements related to a position at which the operation is accepted in the Web content.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating a display example of how an external configuration of a Web page changes;

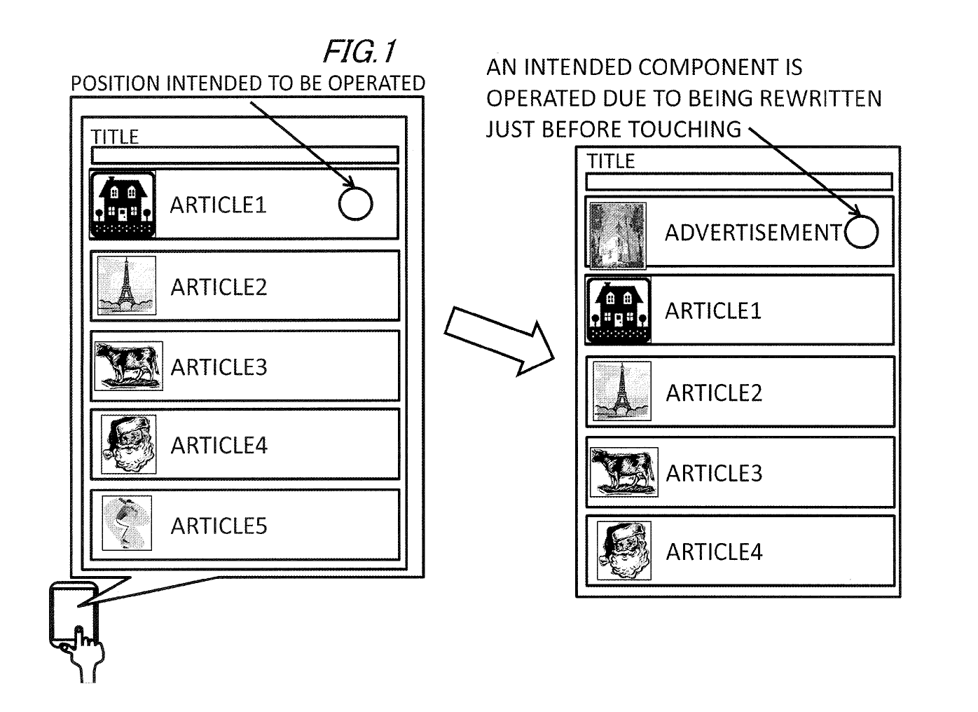

FIG. 2 is a diagram illustrating an example of a screen on which a non-display process of an advertisement is carried out by an advertisement filter according to a comparative example;

FIG. 3 is a diagram illustrating an example in which an advertisement filtering function is unable to prevent a mis-operation in the comparative example;

FIG. 4 is a diagram illustrating a processing example for prompting a user to reselect when tapping on coordinates on which components concentrate on a touch panel in the comparative example;

FIG. 5 is a diagram illustrating a state of not executing the process of prompting the user to reselect for changing a layout;

FIG. 6 is a diagram illustrating a hardware configuration of an information equipment;

FIG. 7 is a diagram illustrating a configuration of a browser;

FIG. 8 is a diagram illustrating a User Interface (UI) for selecting any one of operable components;

FIG. 9 is a diagram of a data example of a history management table;

FIG. 10 is a class diagram for defining the components on the browser;

FIG. 11 is a flowchart given when the information equipment running the browser changes a position of a display element, based on a script and style sheets;

FIG. 12 is a flowchart of processes to be executed when touching a content plane in which the content on the browser is displayed;

FIG. 13 is a flowchart illustrating an example in which the processes are concretely written according to the description of a script language;

FIG. 14 is a sequence diagram in the information equipment.

### DESCRIPTION OF EMBODIMENT(S)

A generation source of a content displayed on a display device of the equipment is the same as a main component to display the content, in which case the equipment itself can control a display method (positions, modes) of the elements contained in the content for preventing a mis-operation.

In the case of the Web content, however, a main component as the generator to execute a content generation process is normally different from the main component to execute a process of displaying the content (e.g., a process of browser). Therefore, when the content generation source embeds, into the Web content, a function of dynamically rewriting the Web content, it follows that a user makes a selection different from a selective intention of the user, depending on selection timing of the user operating the content displayed on the browser and timing at which the Web content is rewritten.

It is an aspect of the embodiment to provide a recording medium storing program, an information processing method and an information processing apparatus that are capable of reducing a mis-operation caused concomitantly with a change of a display content of a Web content.

An information equipment and an information processing method according to one embodiment will hereinafter be described with reference to the drawings. A configuration of the following embodiment is an exemplification, and the present information equipment is not limited to the configuration of the embodiment.

### Comparative Example

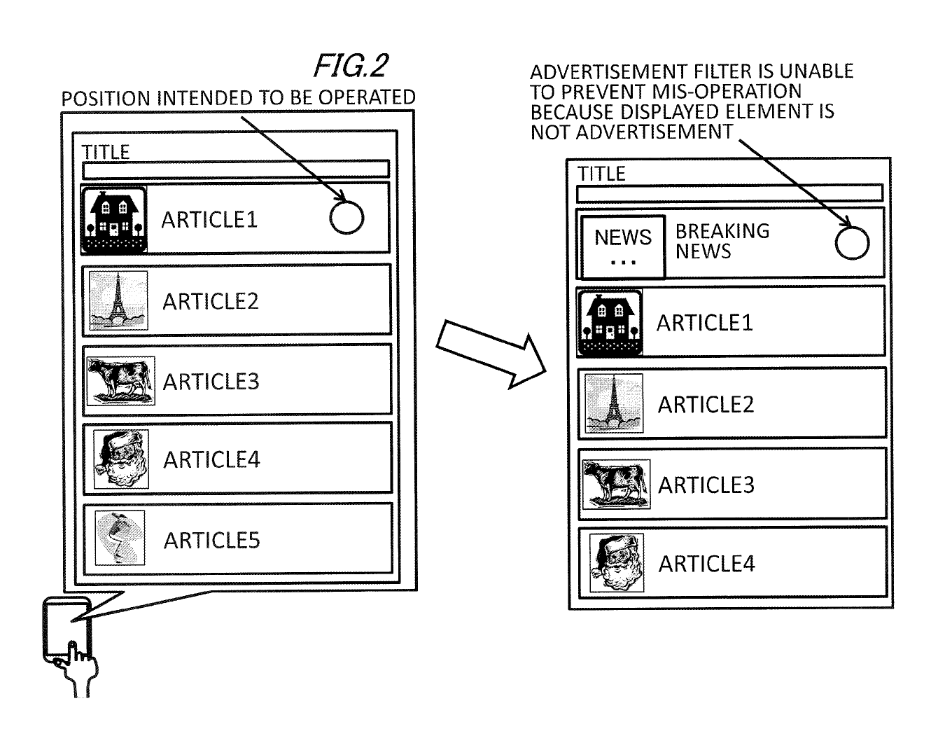

To start with, FIGS. 2 through 4 illustrate processes of the information equipment according to a comparative example. FIG. 2 depicts a screen on which a non-display process of an advertisement is carried out by an advertisement filter. In order for the information equipment to embed an advertisement into a Web page, such a technique is widely used that an advertisement content is asynchronously downloaded and embedded into the Web page in accordance with Asynchronous JavaScript+XML (AJAX) and other equivalent programming languages. Normally, the Web page as a main body is displayed ahead, and the advertisement content is embedded later upon completion of downloading the advertisement content by an asynchronous process. Consequently, it happens as the case may be that components of the Web page as the main body change in their positions. Herein, “the Web page as the main body” connotes a page of a group of elements other than the advertisement within the Web page.

A browser introduces an advertisement filtering function based on a Uniform Resource Locator (URL) Blacklist filtering method for preventing these components from changing in their positions on the information equipment. The browser introduces the advertisement filtering function, thereby interrupting a download process when the information equipment tries to download an advertisement contained in the Blacklist. The interruption of the download process inhibits the component positions from changing concomitantly with displaying the advertisement, and it can be therefore expected that mis-operations are resultantly reduced.

However, a technology concerned is configured to block contents contained in the Blacklist and hence decreases in effect unless the Blacklist is continuously updated. In addition, as illustrated in FIG. 2, it is unfeasible to prevent the mis-operation due to a change in component (which is also referred to as an element) other than the advertisement, e.g., a change in layout of the Web page as the main body.

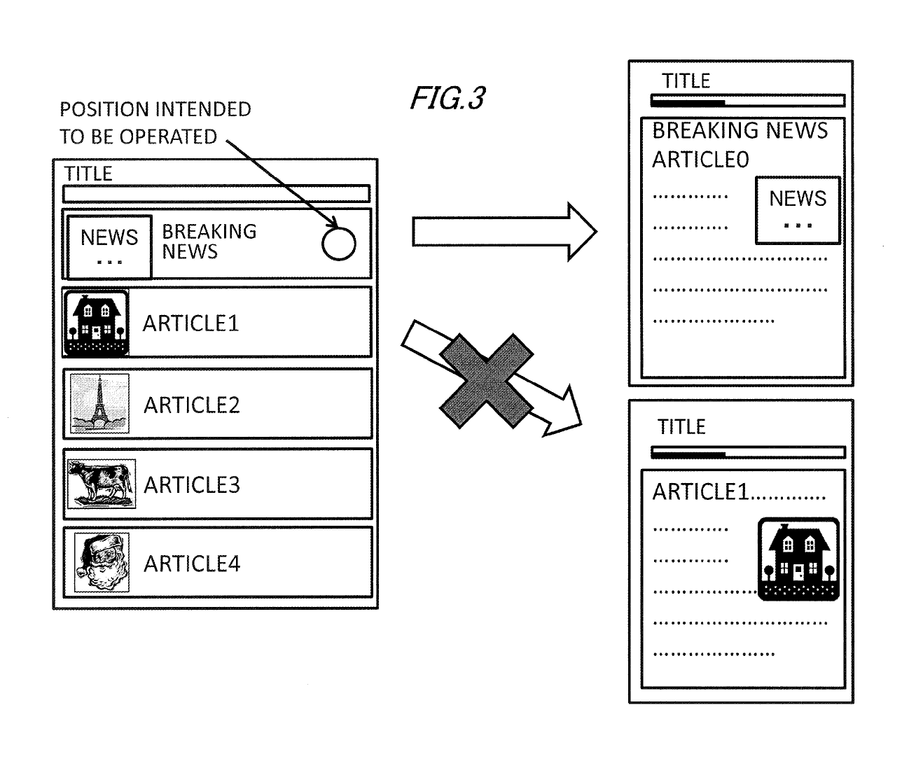

FIG. 3 depicts such a case that the advertisement filtering function is unable to prevent the mis-operation. An example in FIG. 3 is that a title named an article 1 becoming an operation target is changed to a “Breaking News” article 0. With the change as in FIG. 3, the elements to be displayed are not, however, the advertisements, and hence the advertisement filter is unable to prevent the mis-operation. Accordingly, a user operates with an intention of transitioning to the article 1, and nevertheless the article actually operated by the user results in becoming the “Breaking News” article 0, whereby the screen to which user transitions turns out to be a screen of the “Breaking News” article 0.

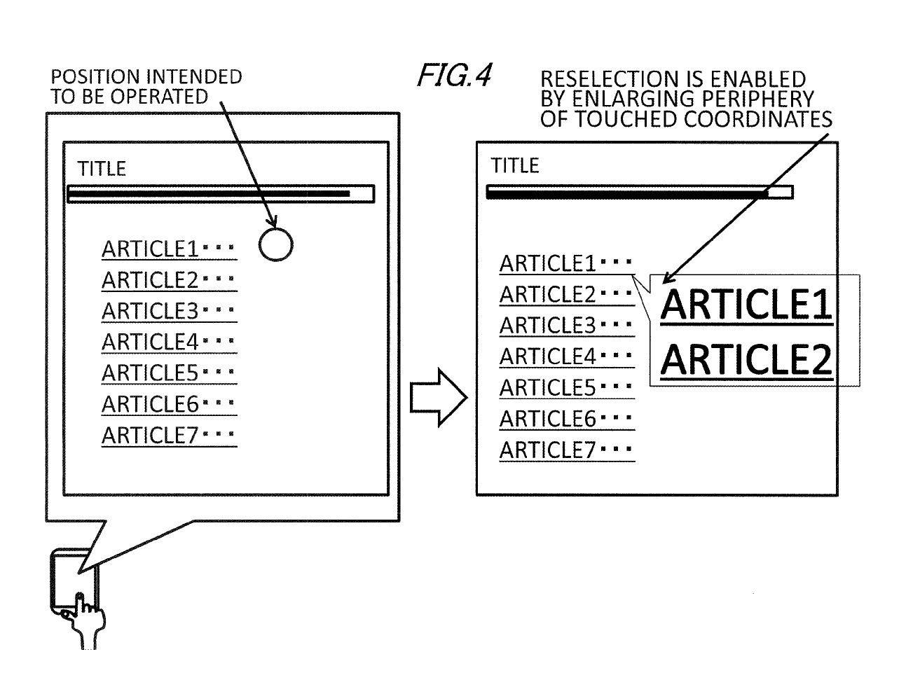

FIG. 4 illustrates a processing example for prompting the user to reselect when tapping on coordinates on which the components concentrate on a touch panel. In this process, when the components concentrate on the vicinity of the touched coordinates, the information equipment prompts the user to redo the operation while enlarging the vicinity of the coordinates. An Internet browser designed mainly for smartphones may implement the function as in FIG. 4.

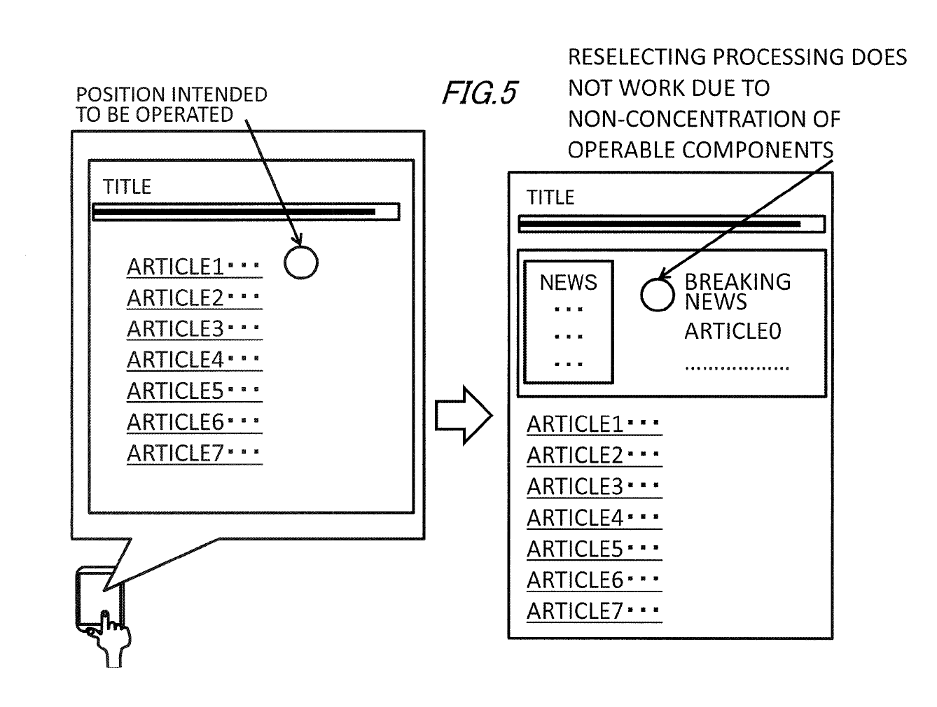

FIG. 5 illustrates a state of not executing a process of prompting the user to make a reselection for changing the layout. The layout is changed by a description of a script language, in which state the layout is changed just when touching as the case may be. In this case, as depicted in FIG. 5, the components do not necessarily concentrate on the vicinity of the touched coordinates in the post-changing layout. The information equipment results in determining that the enlargement of the vicinity of the coordinates is not required in some cases.

A reason why unable to reduce the mis-operations in the comparative example given above derives from a point that generation of the information and the display of the information are processed by different apparatuses. The Web content generator apparatus is different from the Web content display apparatus, and therefore an event described in the comparative example occurs. For example, the browser to display the Web contents does not acquire a sufficient effect from the processing in the comparative example.

### Embodiment

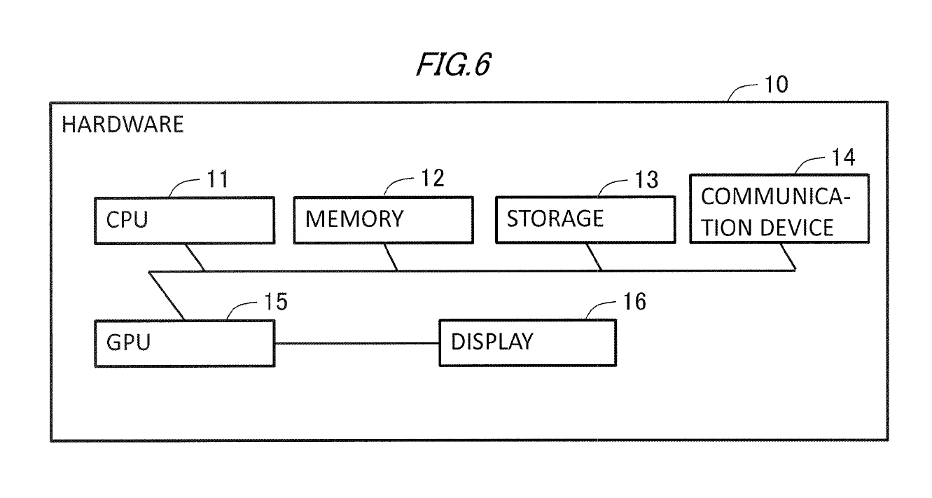

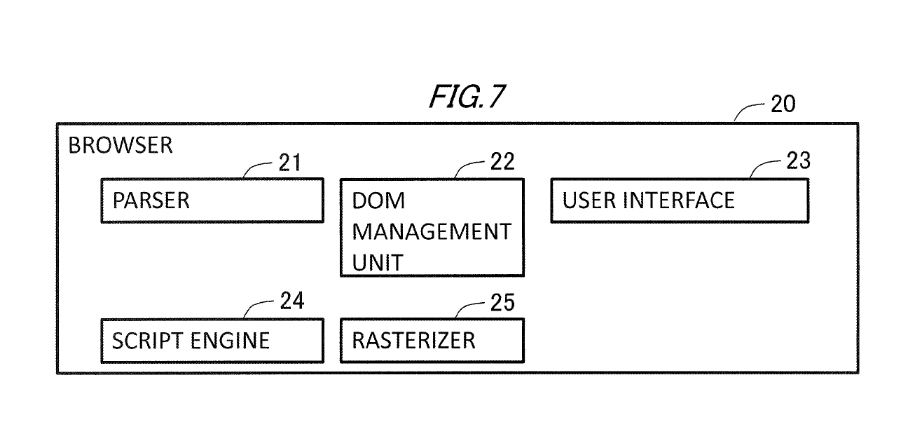

An information equipment 10 according to one embodiment will hereinafter be described with reference to FIGS. 6 through 13. In the following embodiment, when the component is moved based on the script language and the AJAX, the information equipment 10, which runs a browser 20 (see FIG. 7), stores a position and a size of the component immediately before moving the component. The information equipment 10 to run the browser 20, when accepting a touch operation, determines whether the component existing so far immediately before performing the touch operation stays in the coordinates of the position in which the touch operation was performed. When the component exists in the coordinates immediately before performing the touch operation, the information equipment 10 causes the user to determine which operation, an operation for the component existing so far immediately before performing the touch operation or an operation for the component exiting currently, is carried out.

However, a huge storage area is required for the information equipment 10 to store all the components unconditionally, and the information equipment 10 therefore limits a storage period in the embodiment. A method thereof is given as follows.

A scene, in which the mis-operation is easy to occur, is such a case that there is a comparatively short interval between time when the user tries to perform the touch operation and time when the component completes its movement. The component existing so far in a range operable based on the coordinates within a given period of time can be therefore set as a selection target by storing the coordinates and the size of the component and the present time when the component is moved. Such a limitation of the selection target makes it feasible to restrict a number of selectable components, i.e., a storage capacity for storing the components. Note that components combined to configure a graphical user interface (GUI) on the Web contents will be also termed elements of the Web contents (or simply termed the elements) in the following discussion.

### <System Architecture>

FIG. 6 illustrates a hardware configuration of the information equipment 10. The information equipment 10 is an equipment configured by installing an HTML browser into hardware of a computer. The information equipment 10 is exemplified by a smartphone, a tablet terminal, a Personal Digital Assistant (PDA), a personal computer adopting a touch panel, and a mobile phone adopting the touch panel. The information equipment 10 is one example of an “information processing apparatus”.

As in FIG. 6, the information equipment 10 includes a Central Processing unit (CPU) 11, a memory 12, a storage 13, a communication device 14, a Graphical Processing Unit (GPU) 15 and a display 16, and executes information processing in accordance with programs instanced by the browser.

The CPU 11 runs computer programs deployed in an executable manner on the memory 12, thereby providing functions of the information equipment 10. The CPU 11 is one example of a “computer”. The CPU 11 is also one example of a “processor”.

The memory 12 stores the computer programs to be run by the CPU 11, and data or other equivalent software to be processed by the CPU 11. The memory 12 is instanced by a Dynamic Random Access Memory (DRAM), a Static Random Access Memory (SRAM) and a Read Only Memory (ROM). The storage 13 is used as a storage area auxiliary to the memory 12, and stores the computer programs to be run by the CPU 11, and the data or other equivalent software to be processed by the CPU 11. The storage 13 is instanced by a Hard Disk Drive (HDD) and a Solid State Drive (SSD).

The GPU 15 executes a graphics process by cooperating with the CPU 11 or in place of the CPU 11, and outputs post-processing data to the display 16. Herein, the display 16 is instanced by a liquid crystal display and an Electroluminescence (EL) panel. The display 16 is one example of a “display device”.

The information equipment 10 includes an input device, thereby providing a User Interface (UI) together with the display 16. The input device is, e.g., the touch panel. The information equipment 10 may also be, however, provided with buttons, keys and a keyboard as the input devices. The information equipment 10 may further be provided with a drive for a removable storage medium. The removable storage medium is instanced by a flash memory card.

FIG. 7 illustrates a configuration of the browser 20. The browser 20 includes a parser 21, a Document Object Model (DOM) management unit 22, a User Interface (UI) unit 23, a script engine 24, and a rasterizer 25. The information equipment 10 acquires HyperText Markup Language (HTML) documents and various types of resources, e.g., images, source files described by using JavaScript (registered trademark) and other equivalent elements, which are contained in the HTML documents, from the Internet via the communication device 14. However, the HTML documents may also be those previously stored in the storage 13.

The parser 21 converts the HTML document into internal information (Document Object Model (DOM)), and the DOM management unit 22 retains this converted DOM. The DOM management unit 22 executes visualizing the DOM by using the rasterizer 25, based on the retained DOM. For example, raster data are generated by the visualization. The script engine 24 interprets and runs a script described by a language supported by the script engine 24. The script language can be exemplified by JavaScript (registered trademark), and it does not, however, mean that the script language is limited to JavaScript (registered trademark). The script engine 24 executes a description of the script language in a script file (called as a script), thereby enabling the CPU 11 to change a content of the DOM by issuing a change request to the DOM management unit 22. The DOM management unit 22 changes information of the retained DOM in response to a change request given from the script engine 24. A display content is changed based on the changed information of the DOM, in which case the DOM management unit 22 generates the raster data by using the rasterizer 25 for performing again the visualization. Upon completing the visualization, the CPU 11 hands over the raster data to the GPU 15. The GPU 15 generates pixel data based on the raster data handed over from the CPU 11, and displays the pixel data on the display 16.

Upon a trigger caused by a change of the DOM due to the content and a description of the script language, the DOM management unit 22 stores current positions and sizes of the elements to be changed to keep those for a given period of time. The DOM management unit 22 determines whether any component operable within the given period of time exists in the coordinates with the touch operation being performed.

The UI unit 23 instructs the DOM management unit 22 to determine whether any components operable within the given period of time exist in the coordinates with the touch operation being performed. As a result of the determination made by the DOM management unit 22, when the components operable within the given period of time exist in the coordinates with the touch operation being performed, the UI unit 23 displays a user interface (UI) for selecting any one of the currently operable component and the component existing so far within the given period of time.

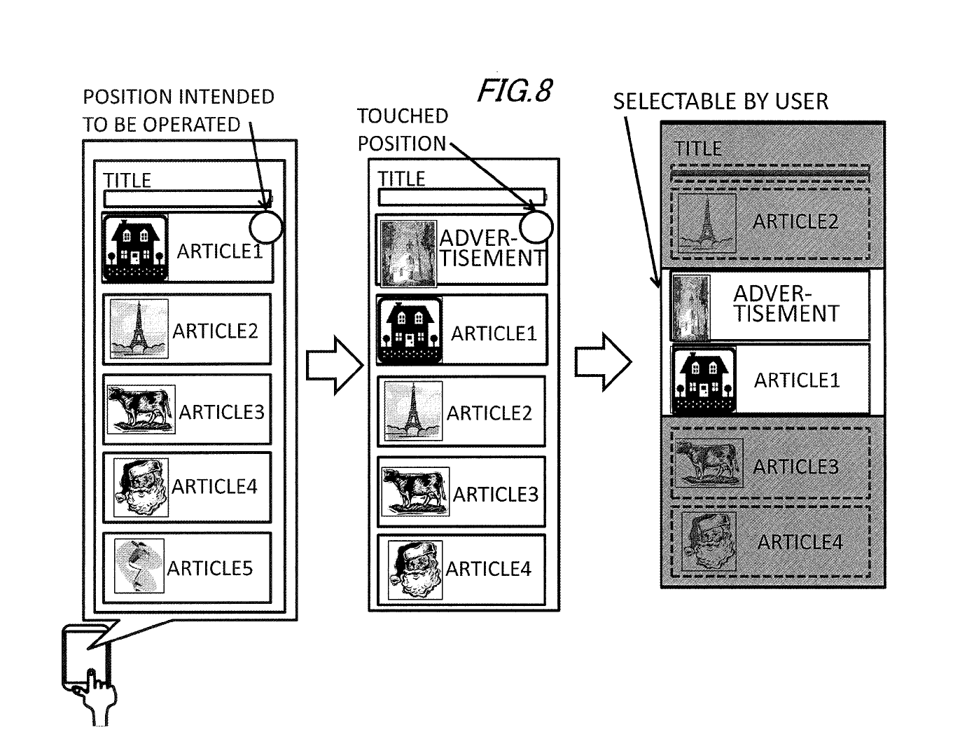

FIG. 8 illustrates the UI for selecting any one of the operable components. In an example of FIG. 8, a component with an indication of a title named “Article 1” is changed to “Advertisement” before a user's touching the screen. “Article 1 through “Article 5” are shifted downward one by one, with the result that “Article 5” disappears from the screen. In this case, the DOM management unit 22 retains identifying information (tag and other equivalent information) of the component of a pre-changing element which had a title “Article 1” displayed in a touched on-screen position, a display position and a dimension of this component for the given period of time. It then follows that the user trying to touch the on-screen position with the indication of the title of “Article 1” displayed touches an on-screen position in which the advertisement is displayed. In this case, the UI unit 23 designates the touched position to the DOM management unit 22, and thus causes the DOM management unit 22 to determine whether any element other than the advertisement exists within the given period of time. In the example of FIG. 8, the DOM management unit 22 determines that the component indicating the title named “Article 1” as the element other than the advertisement has been existing in the touched position within the given period of time. This being the case, the UI unit 23 sorts the component with an indication of the advertisement and the component with an indication of the title named “Article 1” in the form of a list, and displays this list to the user, thus prompting the user to make a further selection.

Note that the UI unit 23 disables the components excluding an operation candidate component from being operated. In the example of FIG. 8, the components other than the component with the indication of the advertisement and the component with the indication of the title named “Article 1” are displayed in an inoperable mode (as instanced by being colored in light gray or rendering a rectangular outer periphery of the component by a dotted line) in the list of the user interface (UI). Note that when the operable component is small and is therefore hard to be selected, the UI unit 23 may enlarge this component to facilitate its operation. In the example of FIG. 8, the information equipment 10 displays the two components as the components operable on the UI unit 23. Three or more operable components exist, in which case the UI unit 23 may prompt the user to select the three or more components by being listed up in the list format in the same way as in FIG. 8.

### <Data Structure>

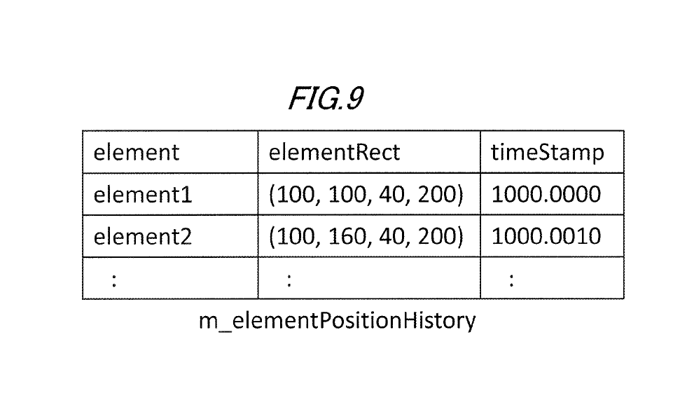

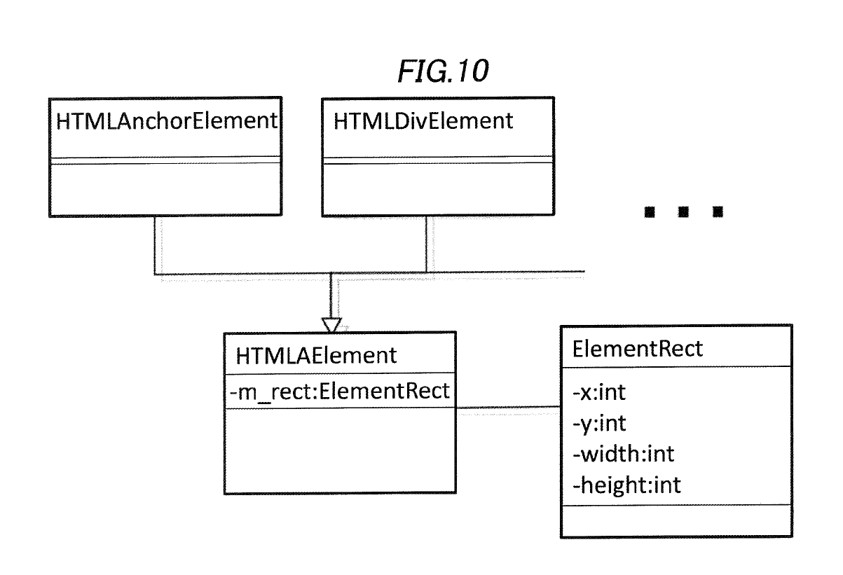

FIGS. 9 and 10 illustrate structures of data to be managed by the DOM management unit 22 of the browser 20. FIG. 9 illustrates a data example of a history management table (m_elementPositionHistory) to store the elements, positions of the elements, dimensions and timestamps when the element positions are changed. The history management table in FIG. 9 has fields (columns), i.e., an “element” field, an “elementRect” field and a “timeStamp” field. Identifiers (also termed tags) of the component defined as the element on the browser are stored in the “element” field. Herein, the component is exemplified by the component indicating the title in FIG. 8 or the component indicating the advertisement. More concretely, the component contains, as depicted in FIG. 10, element's instances, e.g., “HTMLAnchorElement: <a>” and “HTMLDivElement: <div>”.

A position (x, y) and a dimension (w, h) given when recorded in the “timeStamp” field are stored in the “elementRect” field. Herein, the position (x, y) is a position of the componentin a coordinate system of the display 16 of the information equipment 10. The dimension (w, h) includes a width and a height of the component. Note that the embodiment exemplifies the rectangular component as the component, but it does not mean that the component is limited to the rectangular shape. For example, when the component takes a circular shape, the history management table may also be structured to retain a central point (x, y) and a radius r.

Time of the element position being changed is stored in the “timeStamp” field. Note that the history management table may be provided for every window and every tab when taking it into consideration that the HTML browser includes a plurality of windows and a plurality of tabs.

FIG. 10 illustrates a class diagram for defining the components on the browser. The class diagram illustrates an inheritance relationship between the components. For example, elements “HTMLAnchorElement” and “HTMLDivElement” inherit an element “HTMLElement”, and “HTMLElement” has an element “ElementRect”. The element “HTMLElement” is a basic element taking the rectangular shape, and the element “ElementRect” retains the current position (x, y) and the dimension (w, h) of this rectangle. The DOM management unit 22 acquires the current position (x, y) and the dimension (w, h) from “ElementRect” of each component on the browser, and records (x, y) and (w, h) together with the acquired time in the history management table.

### <Processing Flow>

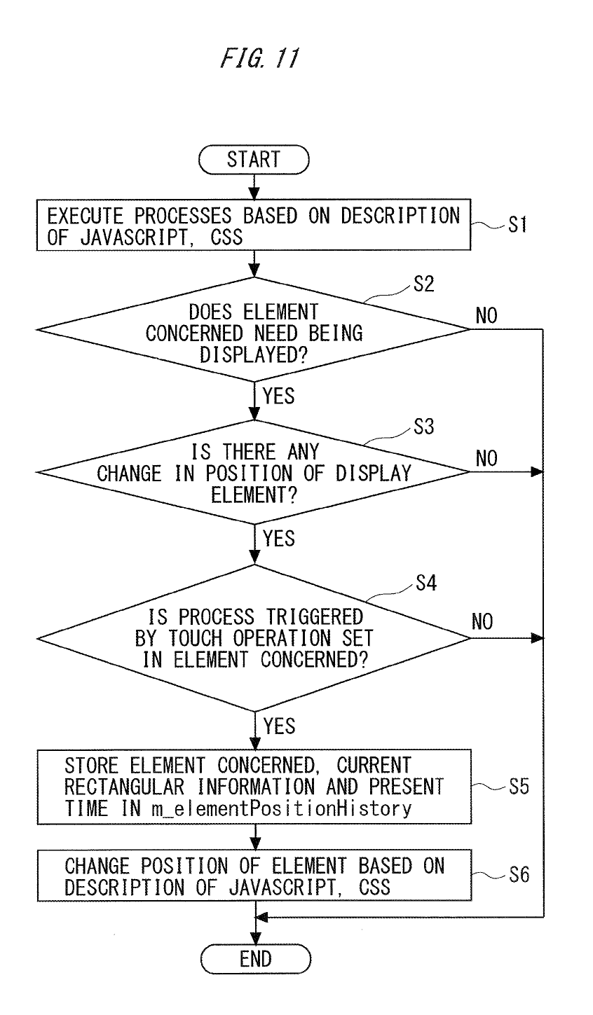

FIG. 11 is a flowchart given when the information equipment 10 running the browser 20 changes the position of the display element, based on the script, AJAX, Cascading Style Sheets (CSS) and other equivalent languages. When a change occurs in the position of the display element, the information equipment 10, after storing the current position, the size and the present time before being changed, changes the position of the element on the browser in accordance with the descriptions of the script or the CSS and so forth. The information equipment 10 does not, however, store elements that are unnecessary for being displayed or elements for which not to set a process (e.g., a program to be run upon occurrence of a tap event) triggered by the touch operation. Herein, the “program to be run upon the occurrence of the tap event” is also called “EventListener”. Even when the process is executed based on the script and the CSS, but, as far as the position is not changed by this process, the information equipment 10 does not store the element. With respect to the elements and the processes described above, there may not be executed the process of prompting the user to select the component from the list of components on the browser. Processes of the information equipment 10 using the browser 20 will hereinafter be described based on FIG. 11.

In an example of FIG. 11, the information equipment 10 executes a process for the elements on the browser in accordance with the description of the script or the CSS (S1). Next, the information equipment 10 determines whether a processing target element is the element to be displayed (which will hereinafter be referred to as a “display element”) (S2). When the component concerned is the display element, the information equipment 10 determines whether the position of the display element changes (S3). The process in S3 is one example of “monitoring whether a position of any of the elements of the Web content changes”. A determination “YES” in S3 is one example of “when the position of any of the elements changes”. When the change occurs in the position of the display element, the information equipment 10 determines whether the process triggered by the touch operation is set for the display element (S4).

The process triggered by the touch operation is set for the display element, in which case the information equipment 10 stores the identifier (tag name), the current position (x, y) and the dimension (w, h) of the display element, and the present time in the history management table of the memory 12 (S5). Herein the history management table is, e.g., “m_elementPositionHistory”. The process in S5 is one example of “storing original positional information of the position changing element in a storage device”. The memory 12 is one example of “a storage device”. The information equipment 10 changes the position of the element in accordance with the description of the script or the CSS and other equivalent languages (S6). The process in S6 exemplifies that at least one position of the elements of the Web content changes asynchronously with the user's operation. Note that when any one of determination results in S2 through S4 is “NO”, the information equipment 10 finishes processing directly.

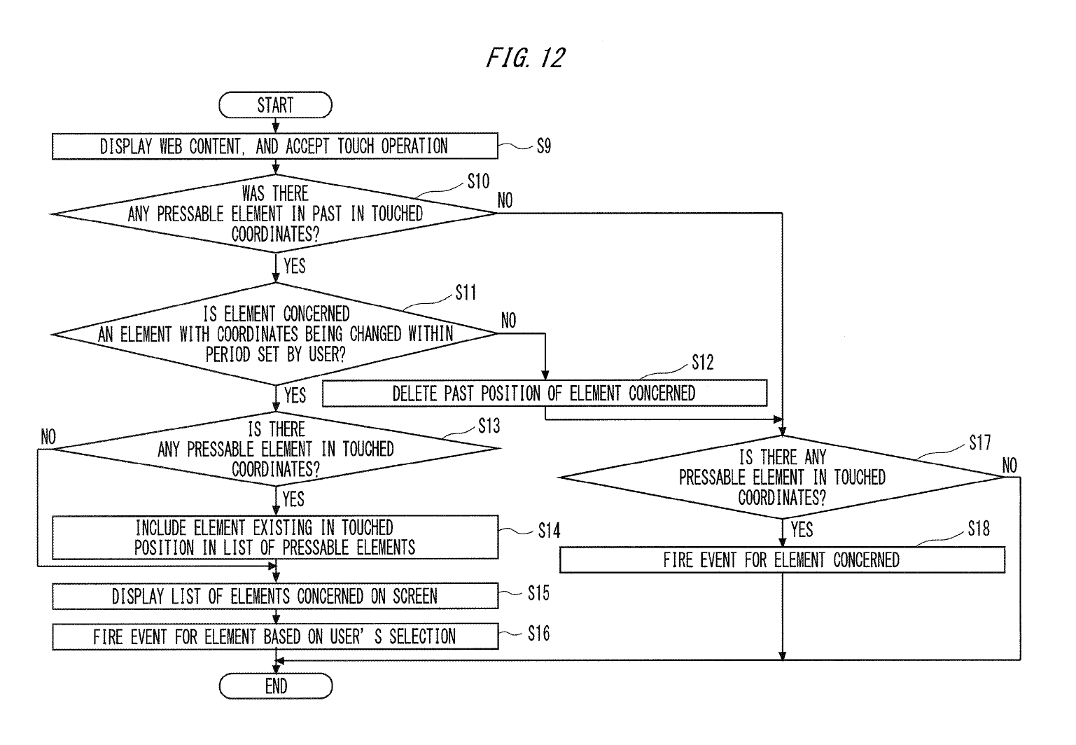

FIG. 12 is a flowchart of processes to be executed when touching an area (which will hereinafter be termed a content plane) in which the content on the browser is displayed. The information equipment 10, at first, displays the Web content on the display 16 mounted with the touch panel for the user, and accepts the operation of touching the element in the Web content (S9). The process in S9 is one example of “accepting a operation performed by user about the displayed Web content”. The information equipment 10 determines whether any pressable element has existed in the past in the touched coordinates (S10). When the pressable element has existed in the past in the touched coordinates, the information equipment 10 determines whether the element concerned is an element, of which coordinates of the display position are changed within a period of time being preset by the user (S11). When the time set by the user elapses, the information equipment 10 does not set the element acquired from the touched coordinates as a target of the pressable component, but deletes the information thereof is deleted (S12). Whereas when the time set by the user does not elapse, the information equipment 10 determines whether the element concerned is the pressable element (S13).

When the element concerned is the pressable element, the information equipment 10 causes a list of pressable elements to contain the element existing in the touched position (S14). The information equipment 10 displays the list of pressable elements on the screen (S15). The process in S15 enables the user to determine whether to select the element concerned or the element having existed in the past when the pressable element exists in the touched coordinates before the given period of time at the present and in the past. Note that S15 is contrived as a process taken into consideration so that the user is enabled to select also the currently existing element by displaying the element with its position being changed in the past and the currently existing element.

The process in S15 is one example of “presenting selection information associated with the operation, the selection information corresponding to a position change of any of elements of the displayed Web content, the selection information being related to timing of the operation and the selection information being configured to specify any of the elements related to a position at which the operation is accepted in the Web content”. Herein, the change status of the position of the element in the Web content is determined in the processes of S10 through S13. It is determined based on the processes in S11 and S12 whether the change status is the change status related to the timing of the user's operation. In other words, e.g., the determination of whether the change status is related to the timing of the user's operation is made depending on whether the coordinates of the display position of the element are changed within the time preset by the user. The processes in S11 and S12 are one example of “retaining the positional information of each of the elements of the Web content for a fixed period of time”. When the coordinates of the display position of the element are changed within the time set by the user before accepting the touch operation in the processes in S9 through S11, the information equipment 10 displays the element concerned as the list of pressable elements on the screen. With the processes in S11 through S15, the position changes of the elements and the user's operation may therefore be said to be in an associative relation within the range of the fixed period of time. It may also be said that the selection information associated with the user's operation is presented corresponding to the change status of the position of the element having the associative relation with the user's operation within the fixed period of time.

The information equipment 10 fires an event for the element, based on user's selection (S16). As a result of S16, e.g., a program runs, which is called EventListener started up when the event occurs.

Whereas when determining in S10 that any pressable element has not existed in the past in the touched coordinates, the information equipment 10 determines whether any pressable element currently exists in the coordinates of the touched position (S17). When the pressable element exists in the coordinates of the touched position, the information equipment 10 fires the event for the element, based on the user's operation (S18). When a plurality of options occurs due to the determination made above, the information equipment 10 can display the screen for prompting the user to select which component is operated in the options concerned as in FIG. 8.

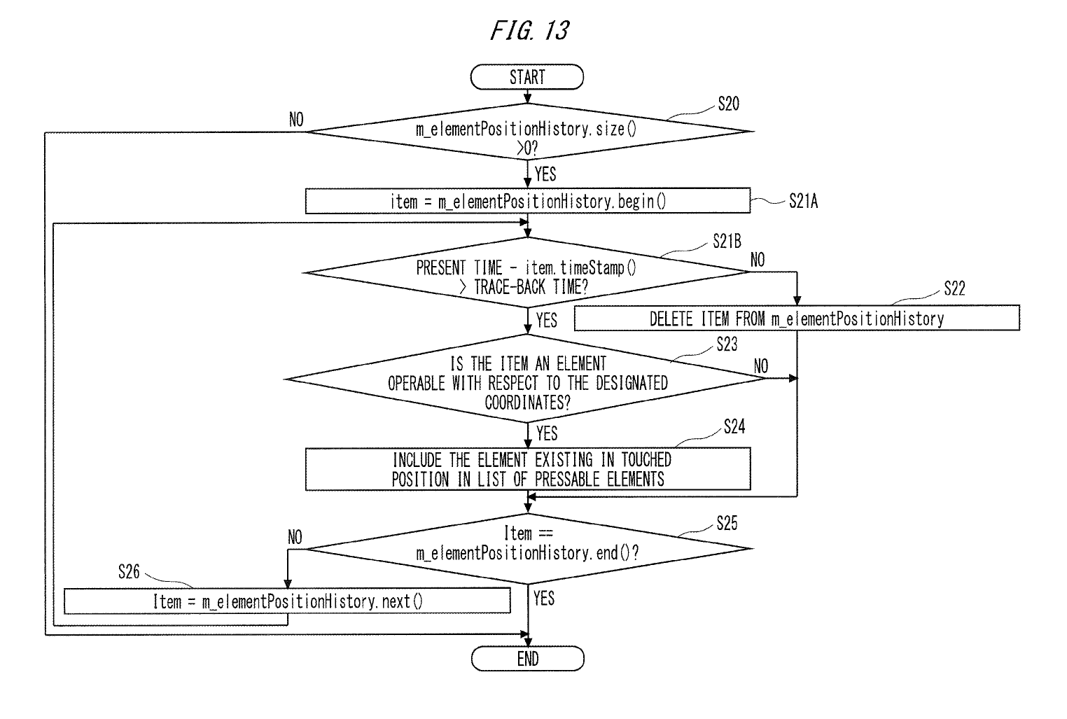

FIG. 13 illustrates an example in which the processes corresponding to S10 through S24 among the processes in FIG. 12 are concretely written according to the description of the script language. In the processes of FIG. 13, the information equipment 10 executes the processes by the DOM management unit 22. The information equipment 10, to begin with, determines whether any pressable element has existed in the past in the touched coordinates. Herein, the information equipment 10 determines whether a size “m_elementPositionHistory.size( )” of the history management table “m_elementPositionHistory” is larger than “0” (S20).

When the determination in S20 is “YES”, the information equipment 10 fetches, into a variable “item”, a head element “m_elementPositionHistory.begin( )” of the history management table “m_elementPositionHistory” (S21A). When the pressable element has existed in the past in the touched coordinates, the information equipment 10 determines whether the coordinates of this element are changed within the time preset by the user. To be specific, the information equipment 10 determines whether the present time and time “item.timeStamp( )” when changing the position of the element fetched into the variable “item” in S21A are longer than time (which is also called trace-back time) preset by the user (S21B).

When the time set by the user elapses, the information equipment 10 does not set the component substituted into the variable “item” as the pressable component having existed in the past, but deletes the information thereof. Specifically, the information equipment 10 deletes “item” from “m_elementPositionHistory” (S22). Whereas when determining in S21B that the time set by the user does not elapse, the information equipment 10 determines whether the component substituted into the variable “item” is an element operable with respect to the designated coordinates (S23). When the component substituted into the variable “item” is the element operable with respect to the designated coordinates, the information equipment 10 causes the list of pressable elements to contain the component substituted into “item”, i.e., to contain the element existing in the touched position (S24). Whereas when the component substituted into “item” is not the element operable with respect to the designated coordinates, the information equipment 10 advances processing to S25.

The information equipment 10 determines whether the element stored in the variable “item” is coincident with a tail end element “m_elementPositionHistory.end( )” of the history management table “m_elementPositionHistory” (S25). When the element stored in the variable “item” is not the tail end element of “m_elementPositionHistory”, the information equipment 10 substitutes a next element “m_elementPositionHistory.next( )” into the variable “item”, and loops back to the process in S21B.

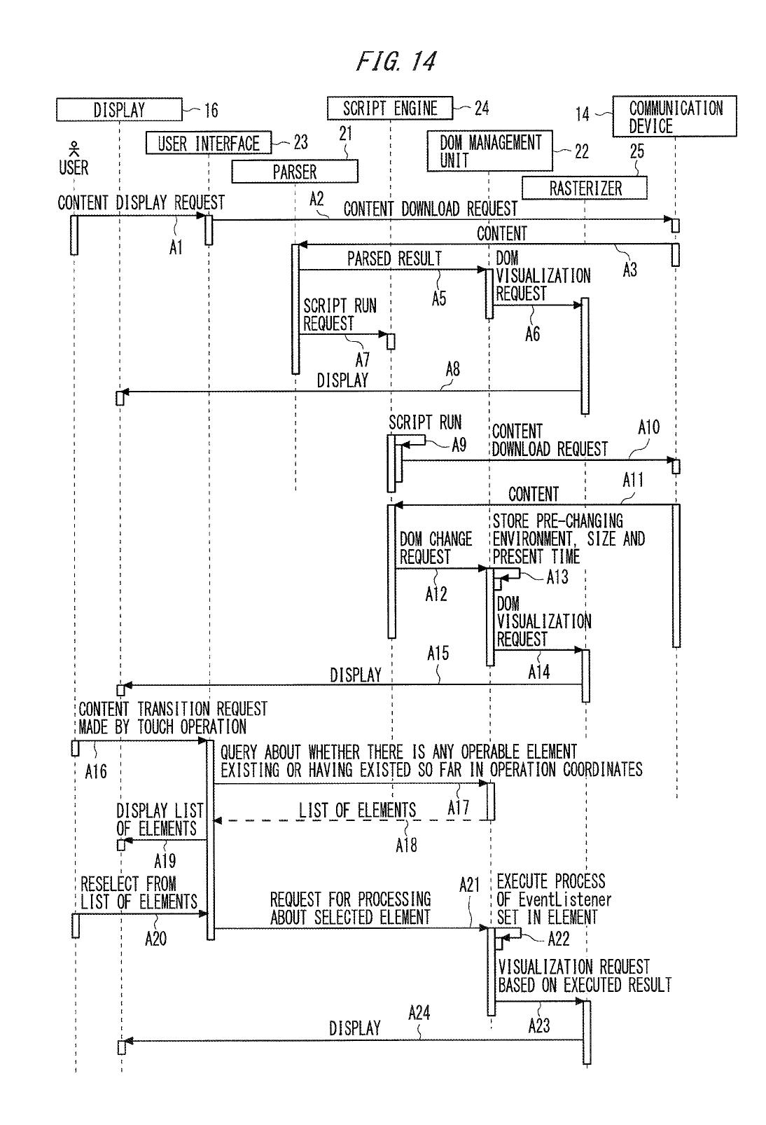

FIG. 14 illustrates a sequence diagram in the information equipment 10. In an example of FIG. 14, to start with, the UI unit 23 accepts the user's operation via the display 16 and the touch panel (arrow line A1). The UI unit 23 transmits a content download request to a Web server and other equivalent apparatuses from the communication device 14 (arrow line A2). The content is then downloaded via the communication device 14 and handed over to the parser 21 (arrow line A3). The parser 21 hands over a parsed result to the DOM management unit 22 (arrow line A5). The DOM management unit 22 requests the rasterizer 25 to visualize the DOM (arrow line A6). The rasterizer 25 displays the content on the display 16 (arrow line A8). Note that the parser 21 requests the script engine 24 to execute script in addition to handing over the parsed result to the DOM management unit 22 (arrow line A7).

In the processing example of FIG. 14, the script based on AJAX and other equivalent languages is executed asynchronously with respect to the element not intended by the user (arrow line A9). As a consequence, the script engine 24 transmits the content download request to the Web server and other equivalent apparatuses from the communication device 14 (arrow line A10). The content is then downloaded via the communication device 14 and handed over to the script engine 24 (arrow line A11).

The script engine 24 requests the DOM management unit 22 to change the DOM (arrow line A12). The DOM management unit 22 accepts the request, and records the coordinates and the dimension of the element, which are defined in the pre-changing DOM, and the present time (arrow line A13). The DOM management unit 22 requests the rasterizer 25 to visualize the DOM (arrow line A14). The rasterizer 25 displays the content on the display 16 (arrow line A15).

On the other hand, the UI unit 23 accepts a content transition request upon the touch operation of the user as the case may be (arrow line A16). In this case, when timing of changing the display by executing the script approximates timing of the touch operation of the user within a short period of time, such a possibility exists as to operate an element different from the element intended by the user.

Upon receiving the content transition request by the touch operation, the UI unit 23 queries the DOM management unit 22 about whether the operable element having existed within the given period of time designated by the user is in a range selectable based on the coordinates of the touched position (arrow line A17). The DOM management unit 22 transmits the list of relevant elements to the UI unit 23 (arrow line A18). When the operable element having existed within the given period of time designated by the user is in the range selectable based on the coordinates of the touched position, there is a doubt about a possibility of a mis-operation. Such being the case, the UI unit 23 prompts the user to make a reselection based on the information retained by the DOM management unit 22. In other words, the UI unit 23 displays the list of elements on the display 16 (arrow line A19). As a result of the processes indicated by the arrow lines A16-A18, the list of elements displayed as indicated by the arrow line A19 is the list of elements having existed in the range selectable based on the coordinates of the touched position within the given period of time before from the time when the user has performed the touch operation as indicated by the arrow line A16 but having been changed in their positions. Accordingly, the processes of the arrow lines A16-A19 may be said to be an example of a process of presenting the selection information associated with the user's operation, corresponding to such a status that the position changes of the elements and the user's operation are in an associative relation in a range of a fixed period of time.

The UI unit 23 receives a user's selecting operation (reselection) from the list of elements (arrow line A20). A possibility of the user making a mis-selection is reduced because of receiving the selecting operation from the list of elements. The UI unit 23 requests the DOM management unit 22 for a process about the selected element (arrow line A21).

The DOM management unit 22 executes the processes of the program instanced by EventListener set in the element (arrow line A22). The DOM management unit 22 requests the rasterizer 25 for the visualization, based on a result of running the program (arrow line A23). The rasterizer 25 displays the running result on the display 16 (arrow line A24).

### <Effect of Embodiment>

As discussed above, according to the information equipment 10 of the embodiment, when the DOM change request occurs due to executing the scripting, the DOM management unit 22 detects the change, concomitant with the change of the DOM, of the element displayed on the browser 20. The DOM management unit 22 stores the pre-changing coordinates and the size of the changed element, and the present time in the history management table. The UI unit 23, when accepting the operation about the Web content displayed on the display 16, queries the DOM management unit 22 about the elements existing or having existed operably in the vicinity of the coordinates of the operated position. The UI unit 23 displays the list of elements concerned on the display 16, and accepts the user's selection. Hence, even when the scripting based on AJAX and other equivalent languages is executed asynchronously with respect to the element not intended by the user and when the element on the browser is changed, the user is enabled to perform the operation for the intended element after rechecking. It is therefore feasible to restrain the element different from the element intended by the user from being operated even when the timing of changing the display by executing the scripting approximates the timing of the touch operation of the user within the short period of time.

With the processes in S11 through S15, it may be said that the selection information associated with the user's operation is presented, corresponding to such a status that the change of the element position and the user's operation are in the associative relation in the range of the fixed period of time. The information equipment 10 is therefore enabled to present the selection information associated with the user's operation, while restraining a usage quantity of the memory 12 from increasing.

According to the embodiment, with the processes indicated by the arrow lines A16-A19, the selection information associated with the user's operation is presented, corresponding to the status that the change of the element position and the user's operation are in the associative relation in the range of the fixed period of time. The information equipment 10 is therefore enabled to present the selection information associated with the user's operation, while restraining the usage quantity of the memory 12 from increasing.

According to the embodiment, the DOM management unit 22 deletes the elements stored in the history management table “m_elementPositionHistory” when the time longer than the given period of time elapses since the time of changing the element concerned. The information equipment 10 is therefore enabled to restrict a capacity in a way that restrains a situation in which the capacity of the history management table augments endlessly.

According to the embodiment, the information equipment 10 determines in the process of S3 of the DOM management unit 22 whether the change occurs in the position of the display element, and stores the identifier, the current position and the dimension of the display element, and the present time in the history management table when the change occurs in the position of the display element. The information equipment 10 is therefore enabled to surely acquire the change of the position of the display element and to store the change in the history management table in accordance with the DOM management process of the DOM management unit 22.

According to the embodiment, the information equipment 10 changes the position of the element of the Web content displayed on the browser 20 in accordance with the description of the script, AJAX or CSS in the process of S6 by the DOM management unit 22. In the embodiment, as by the information equipment 10, the processing target is therefore said to be the element, of which the position is changed asynchronously with the user's operation, based on the description of the script, AJAX or CSS. In other words, the processes according to the embodiment enable the information equipment 10 to restrain the mis-operation about the Web content containing the elements, of which the positions are changed asynchronously with the user's operation that is easy to induce the mis-operation.

### <Computer Readable Non-Transitory Recording Medium>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a ROM (Read-Only Memory) and other equivalent recording mediums are given as the non-transitory recording mediums fixed within the computer and other equivalent apparatuses. Further, a Solid State Drive (SSD) is also available as the non-transitory recording medium removable from the computer and other equivalent apparatuses and also as the non-transitory recording medium fixed within the computer and other equivalent apparatuses.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such example in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A computer readable non-transitory recording medium storing a program that causes a computer to perform:
accepting a operation performed by user about a displayed Web content; and
presenting selection information associated with the operation, the selection information corresponding to a position change of any of elements of the displayed Web content, the selection information being related to timing of the operation and the selection information being configured to specify any of the elements related to a position at which the operation is accepted in the Web content.

2. The program according to claim 1, wherein the position changes of the elements and the user's operation are in an associative relation in a range of a fixed period of time.

3. The program according to claim 1, further causing the computer to retain positional information of each of the elements of the Web content for the fixed period of time.

4. The program according to claim 1, further causing the computer to monitor whether a position of any of the elements of the Web content changes, and, when the position of any of the elements changes, to store original positional information of the position changing element in a storage device.

5. The program according to claim 1, wherein at least one position of the elements of the Web content changes asynchronously with the user's operation.

6. An information processing method by a computer, comprising:
accepting a operation performed by user about a displayed Web content; and
presenting selection information associated with the operation, the selection information corresponding to a position change of any of elements of the displayed Web content, the selection information being related to timing of the operation and the selection information being configured to specify any of the elements related to a position at which the operation is accepted in the Web content.

7. An information processing apparatus comprising:
a memory; and
a processor coupled to the memory and configured to:
accept a operation performed by user about a Web content displayed on a display device; and
present selection information associated with the operation, the selection information corresponding to a position change of any of elements of the displayed Web content, the selection information being related to timing of the operation and the selection information being configured to specify any of the elements related to a position at which the operation is accepted in the Web content.
